(19) United States
(12) Patent Application Publication
(10) Pub. No.: US 2005/0206146 A1
(43) Pub. Date: Sep. 22, 2005

(54) Airbag

(76) Inventor: Jeffery S. Blackburn, Lake Orion, MI (US)

Correspondence Address: Laurence C. Begin;L.C. Begin & Associates, PLLC, PMB 403, 510 Highland Avenue, Milford, MI, 48381, US

(21) Appl. No.: 10/994,048

(22) Filed: Nov. 19, 2004

Related U.S. Application Data
(60) Provisional application No. 60/523,795, filed on Nov. 20, 2003.

(51) Int. Cl. B60R 21/16

(52) U.S. Cl. 280/743.1

(57) ABSTRACT

The present invention includes a vehicle occupant protection system 32 including an airbag 12/22 formed from an olefin or polyolefin. The airbag 12/22 is preferably formed from a single polyolefin such as polyethylene, whereby multiple layers are cross-laminated to form an airbag 12/22 that exhibits optimum shape and inhibits tear propagation upon airbag deployment.

### CROSS-REFERENCE TO RELATED APPLICATIONS

This application claims the benefit of U.S. Provisional Application Ser. No. 60/523,795 filed Nov. 20, 2003.

### FIELD OF THE INVENTION

The present invention relates to an airbag device containing a lightweight airbag. More specifically, the present invention includes an airbag that exhibits high strength, is lightweight, and inhibits tear propagation.

### BACKGROUND OF THE INVENTION

Typical airbags are manufactured from panels of either Nylon or polyester fabric that are joined together by sewing, for example. The airbag is typically coated on the inside with neoprene or silicone thereby capturing hot particles upon gas generator activation and preventing holes from being burned in the airbag fabric. Furthermore, the silicone or neoprene also functions to seal the airbag to prevent gas leakage upon airbag activation. In the case of a driver side airbag, the cushion is typically formed from two nylon circular panels sewn together along their respective peripheries with a silicone-coated side facing out. The airbag is then inverted to orient the coated side internal of the airbag. The back panel is provided with a hole for attachment to an inflator. Tethers made from fabric straps are then typically sewn to the back panel adjacent the inflator attachment hole. Airbags not having tethers typically take a spherical shape once inflated whereby a desired shape is more elliptical thereby providing more surface area for contact with the driver. This is particularly described in U.S. Pat. No. 6,149,194, herein incorporated by reference.

Another safety concern is the weight of the airbag. Current efforts on airbag design include reductions in weight thereby enhancing the safety features of the airbag.

Current designs of polymeric driver-side airbags feature lightweight cushions that because of their respective compositions naturally attain an elliptical shape, without the need for tethers. However, polymeric airbags that naturally attain an elliptical shape also exhibit problematic tear propagation because of their typical inelasticity. As a result, these particular airbags are often reinforced by adding different layers of different compositions, for example. Specifically, one solution is to provide an inelastic polymeric layer adhesively fixed to an elastic polymeric layer thereby providing the requisite shape while inhibiting potential tear propagation of the airbag upon deployment. Although apparently effective, the manufacturing complexity and cost of this type of airbag is increased.

Accordingly, minimizing airbag manufacturing complexity and costs, while retaining the benefits of a lightweight and durable airbag, would be an improvement in the art.

### SUMMARY OF THE INVENTION

The above-referenced problems are solved by an airbag formed from a high density olefin. The airbag is preferably formed from a single polyolefin such as polyethylene, whereby multiple layers are cross-laminated to form an airbag that exhibits optimum shape and inhibits tear propagation upon airbag deployment. In lieu of sewing, the airbag may be hot melted with or without adhesives to form seams and to join opposing edges, or to join opposing panels if multiple panels are employed when forming the airbag.

### BRIEF DESCRIPTION OF THE DRAWINGS

FIG. 1 exemplifies a driver side inflator useful in conjunction with an airbag of the present invention.

FIG. 2 exemplifies a head side curtain inflator useful in conjunction with an airbag of the present invention.

FIG. 3 illustrates a driver side airbag in a deployed state, formed in accordance with the present invention.

FIG. 4 illustrates a side curtain airbag formed in accordance with the present invention.

FIG. 5 illustrates a vehicle occupant protection system containing at least one airbag formed in accordance with the present invention.

### DETAILED DESCRIPTION OF THE PREFERRED EMBODIMENT(S)

The present invention includes an airbag 12 used within an occupant restraint device 10 preferably constructed of a non-woven spunbonded olefin sheet, available under the proprietary name of Tyvek®, or preferably constructed of a cross-laminated high-density polyolefin film, available under the proprietary name of Valeron®. “Spunbonded” is a term known in the art, as described in U.S. Pat. No. 6,488,801, for example. It has been found that airbags formed from spunbonded nonwoven olefins form better seals than other polymeric airbags known in the art. In general, the airbag 12 is constructed of a relatively lighter and thinner fabric than from airbag fabrics generally used in the art. As such, the lightweight airbag 12 is more readily folded and the packing density is decreased thereby requiring an overall smaller package size, and thus providing significant assembly and manufacturing advantages.

Valeron® is marketed by Van Leeer Flexibles, Inc. of Houston, Tex. and is made from high density oriented and cross-laminated polyethylene, and is recognized as being puncture-resistant, tear-resistant, and chemically resistant. The preferred film is strong, with a smooth surface, balanced tear-resistance, and of uniform thickness. The film maintains its properties in harsh environments and has a temperature operating range from −70 to over 200 degrees Fahrenheit. The film is annealed or subjected to a higher temperature (from 35 degrees Celsius to just below the melting point of the plastic) thereby providing higher strength than unannealed counterparts. A preferred airbag consists of cross-laminated polyethylene, and more broadly, cross-laminated polyolefin given the advantages given above. A preferred vehicle occupant protection system contains an airbag formed from cross-laminated polyethylene.

Material particularly well-suited for airbag construction is spunbonded nonwoven polyolefin film-fibrils of the type disclosed in U.S. Pat. No. 3,169,899, herein incorporated by reference. Such spunbonded sheets preferably have been thermally bonded as disclosed in U.S. Pat. No. 3,532,589, herein incorporated by reference, or have been calendar bonded, as disclosed in PCT Publication No. WO 97/40224 and also herein incorporated by reference, in order to provide desired air barrier, water barrier, moisture vapor transmission, and strength properties. The term “polyolefin” is intended to mean any of a series of largely saturated open chain polymeric hydrocarbons composed only of carbon and hydrogen. Typical polyolefins include, but are not limited to, polyethylene, polypropylene, polymethylpentene, and various combinations of the monomers ethylene, propylene, and methylpentene.

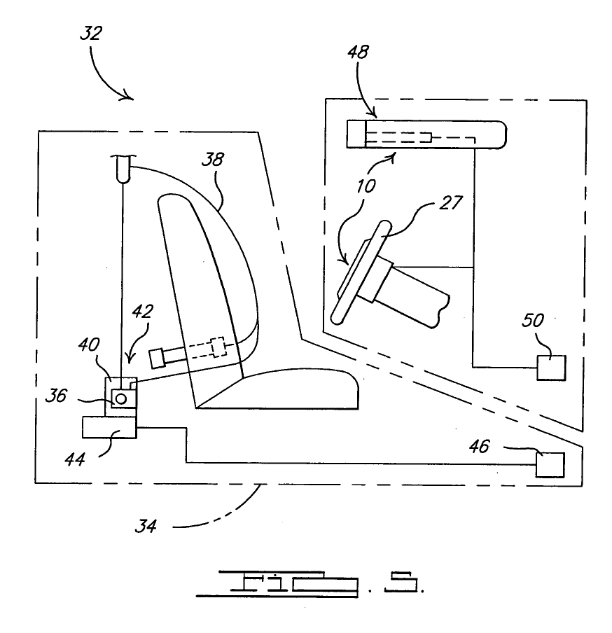

A most preferred material is a nonporous cross-laminated spunbonded polyethylene. It has been unexpectedly discovered that this material, unlike many other polymeric films, may be singularly employed as an airbag material. In particular, the elastic and tear-resistant nature of polyolefins, and most preferably polyethylene in cross-laminated layers, presents an improvement in airbag design not previously realized. As such, the airbag manufacture may be simplified while retaining high quality and reliable air cushions 12. One preferred application of the nonporous airbag is within a side curtain airbag 22 as exemplified in FIG. 4, whereby upon deployment, the pressure is retained thereby providing prolonged protection, during a rollover event for example.

Other similarly engineered polymeric films will be apparent to those of ordinary skill in the art. U.S. Pat. Nos. 6,626,312, 6,579,584, 6,286,145, H1,989, U.S. Pat. Nos. 6,488,801, 6,364,341, 6,447,005, 6,641,896, and 6,355,333, all herein incorporated by reference, describe but do not limit exemplary and other suitable polymeric or plastic films, and if desired, may be useful in the present invention. Stated another way, the present invention preferably includes an airbag preferably formed from cross-laminated layers of one polyolefinic material 16. However, as exemplified in FIG. 3, one or more additional layers 18, 20 made from materials recognized for their suitability within an airbag may be included to satisfy other design criteria. As also shown in FIG. 3, an occupant restraint device 10 includes an airbag module (not shown), an airbag 12, and an inflator 26 in fluid communication with the airbag 12 upon activation thereof. One of ordinary skill in the art will appreciate the commercial availability of a number of other polymeric or otherwise formed layers that may be adhesively or otherwise bonded to the polyolefinic layers in a known manner. See U.S. Patent No. H1,989, for example.

In yet another aspect of the invention, the porosity or gas permeability of the respective fabrics may be tailored by methods known in the art. Exemplary U.S. Patent No. H1,989 and U.S. Pat. No. 6,488,801 describe methods to tailor the porosity from zero permeability to various greater permeabilities thereby facilitating a venting advantage not heretofore known in the airbag art. Accordingly, the porosity of the airbag 12, 22 may extend across the entire airbag, or, the airbag 12, 22 may have portions of porosity by selectively applying adhesive nonporous strips or portions to the microporous film. Attenuating the porosity or permeability of the airbag material by applying nonporous adhesive portions on an outer or inner surface of the airbag will provide a controlled venting function while retaining the pressurized conditions within the airbag for an acceptable period of time.

Stated another way, the porosity and associated venting may be iteratively determined by evaluating the drop in airbag pressure over time. As described in U.S. Pat. No. 6,488,801, it is believed that isotactic polypropylene is particularly suited for adjusted porosity and therefore exemplifies a preferred material when manufacturing a porous airbag, although other isotactic polyolefins may also be employed.

Conventional airbags are constructed of a woven fabric with sewn seams. Gas permeability is controlled by the tightness of the weave or by a silicone or other coating applied to the woven fabric. In yet another aspect of the present invention, the non-woven olefin or polyolefin sheets of the present invention may be manufactured having a desired permeability or may be manufactured to have no permeability. As such, the manufacture of the airbag 12 may be tailored to accommodate specific porosity for application to different areas in the vehicle. For example, the side airbag or head curtain airbag 22 may be manufactured with no permeability to ensure that during a roll-over event the airbag 22 sustains inflation and protects the occupant for the duration of the roll. On the other hand, for a driver-side or passenger-side airbag, it may be desirable to tailor the permeability or porosity of the fabric to provide a natural venting feature without having to actually form or cut vents in the airbag as now known in the art. These porous materials may be supplied by Kimberly-Clark Worldwide, Inc. of Neenah, Wis., for example.

The airbag as exemplified in the drawings, but not thereby limited, may be formed in any shape now known or contemplated hereafter. The material employed is cut into one or more panels and formed into a desired shape. In yet another aspect of the invention, after shaping or providing the requisite panel or panels, the seams of the airbag are preferably sealed using an EVA type hot melt adhesive, or an acrylic adhesive or tape, or a low density polyethylene heat seal, for example. As such, the labor intensive sewing of the airbag panel(s) is not required thereby again providing a significant manufacturing and performance advantage given the ease of sealing and given the elimination of the possibility of gas leakage through the seam(s). As shown in FIG. 4, a plurality of chambers may be formed within the airbag by defining the periphery of each chamber and hot melting through the bag to form partially closed chambers within the airbag.

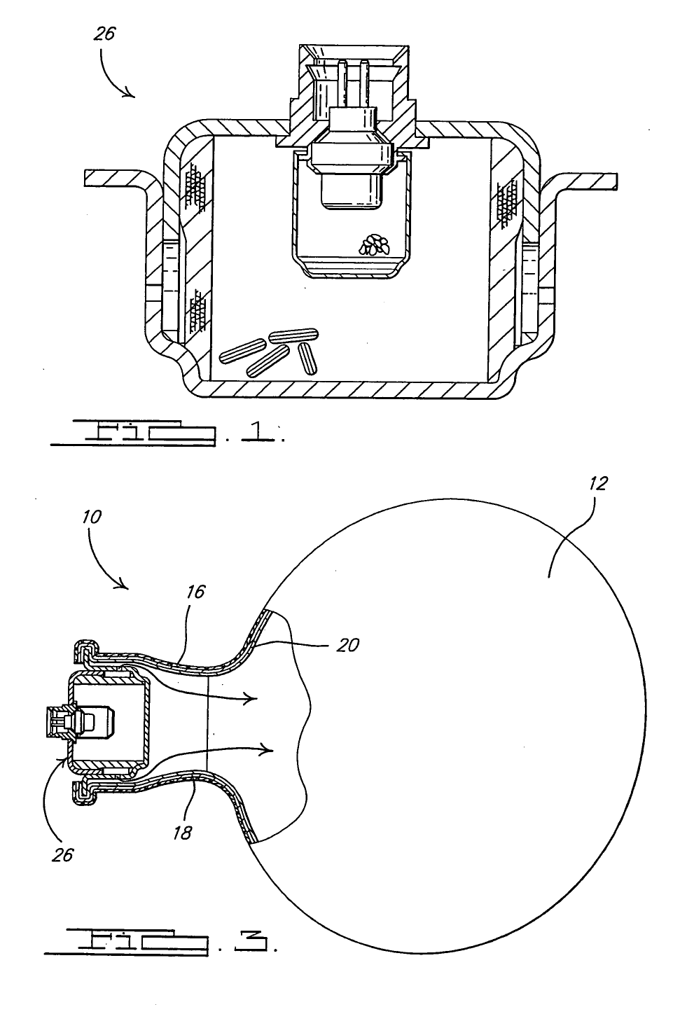

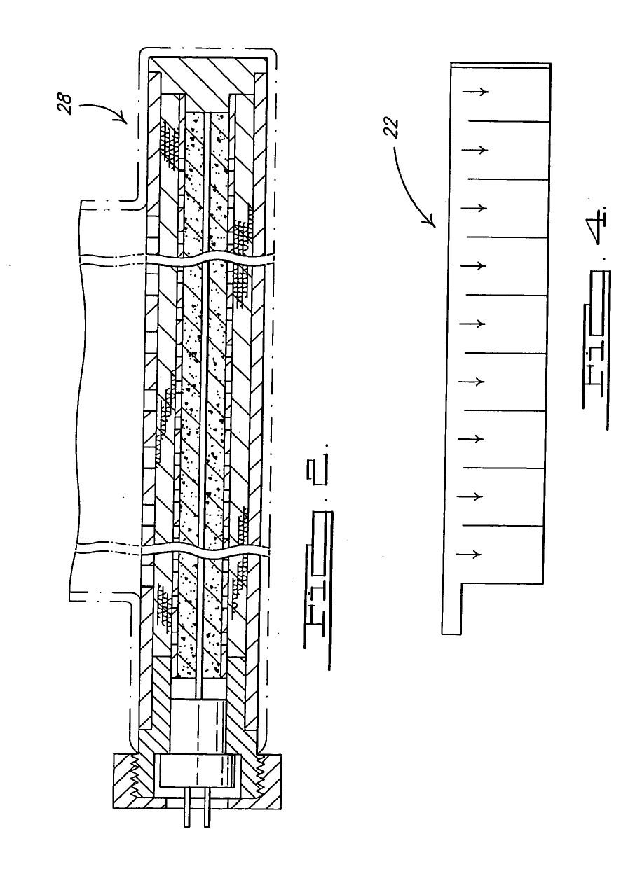

The present invention includes an airbag system or occupant restraint device 10 that contains an airbag 12, 22 formed in accordance with the present invention. The airbag system 10 also contains an airbag inflator 26, 28 assembled in a known manner, as exemplified in U.S. Pat. Nos. 6,749,219 and 6,805,377, each herein incorporated by reference. FIGS. 1 and 2 illustrate a driver side inflator 26 and a head side curtain inflator 28, although the system 10 is not thereby limited. FIGS. 3 and 4 illustrate a deployed driver side airbag 12 and a side curtain airbag 22 formed in accordance with present invention.

In yet another aspect of the invention shown in FIG. 5, airbag system or occupant restraint device 10 may also be incorporated into a broader, more comprehensive vehicle occupant restraint system 32 including additional elements such as a safety belt assembly 34. Safety belt assembly 34 includes a safety belt housing 36 and a safety belt 38 extending from housing 36. A safety belt retractor mechanism 40 (for example, a springloaded mechanism) may be coupled to an end portion 42 of the belt. In addition, a safety belt pretensioner 44 may be coupled to belt retractor mechanism 40 to actuate the retractor mechanism in the event of a collision. Typical seat belt retractor mechanisms which may be used in conjunction with the safety belt embodiments of the present invention are described in U.S. Pat. Nos. 5,743,480, 5,553,803, 5,667,161, 5,451,008, 4,558,832 and 4,597,546, incorporated herein by reference. Illustrative examples of typical pretensioners with which the safety belt embodiments of the present invention may be combined are described in U.S. Pat. Nos. 6,505,790 and 6,419,177, incorporated herein by reference.

Safety belt system 34 may be in communication with a crash event sensor 46 (for example, an inertia sensor or an accelerometer) including a known crash sensor algorithm that signals actuation of belt pretensioner 44 via, for example, activation of a pyrotechnic igniter (not shown) incorporated into the pretensioner 44. U.S. Pat. Nos. 6,505,790 and 6,419,177, previously incorporated herein by reference, provide illustrative examples of pretensioners actuated in such a manner.

Referring to FIG. 5, the driver side inflator 26 shown in FIG. 1 and the driver side airbag 12 of FIG. 3 may be stored within steering wheel 27, for activation upon a crash event; see occupant restraint device 10 stored in the steering wheel 27. Again referring to FIG. 5, the head curtain inflator 28 shown in FIG. 2 and the associated head curtain 22 shown in FIG. 4 may be stored within the vehicle head trim 48 prior to activation thereof. It will be appreciated that either device 10 may be activated by a crash sensor 50 in a manner known in the art.

In yet another aspect of the invention, a method of forming an airbag is defined as providing at least one airbag panel formed from a cross-laminated plurality of layers of a polyolefin, preferably nonporous polyethylene. If only one panel is employed, then opposing edges are folded over and mated thereby providing the desired shape of the airbag or air curtain. If more than one panel is provided, then the panels are mated as per design criteria and the mated edges of each panel are then hot ironed or melted together to form sealed edges and therefore a sealed airbag upon inflation thereof. Various chambers within the airbag may be formed in the same way, that is by defining the volume of the chamber and then applying an iron or melt to the appropriate section of the airbag. If a porous material is employed, the same steps are taken. Afterwards, the inflation and deflation profile of the airbag may be iteratively tailored by inflating the airbag and then increasing or decreasing the porosity incrementally thereby meeting manufacturer requirements. Attenuation of the deflation rate may be accomplished by simply increasing the sealed portions of the porous material by adding nonporous strips to the exterior of the airbag for example.

Stated another way, the airbag method of manufacture may include the following steps:
1. providing at least one panel formed from a nonwoven spunbonded olefin, or from a cross-laminated plurality of layers of a polyolefin, preferably polyethylene, wherein the panel defines a plurality of opposed edges;
2. mating or joining the opposed edges to form a desired shape; and
3. ironing or otherwise melting the opposed edges to form a sealed airbag when nonporous material is used, or, to form a controlled ventilation airbag when porous material is used.
   The above-referenced method may be augmented by:
1. providing at least one panel, and if desired two or more panels, whereby each panel is formed from cross-laminated layers of high density polyolefin, preferably polyethylene, wherein the first panel defines a first plurality of opposed edges, and the second panel defines a second plurality of opposed edges corresponding to the first plurality of opposed edges;
2. overlaying the first panel over the second panel to join the first and second pluralities of opposed edges; and
3. ironing or melting the first and second pluralities of opposed edges together to form an airbag.

The present description is for illustrative purposes only and should not be construed to narrow the breadth of the present invention in any way. Thus, those skilled in the art will appreciate that various modifications might be made to the presently disclosed embodiments without departing from the spirit and scope of the present invention. For example, airbags may be formed for other areas of an automobile such as a passenger side airbag. Other aspects, features and advantages not described above will therefore be apparent to one of ordinary skill in the art.

1. An airbag device comprising:
an airbag formed from a material consisting essentially of a polymeric material selected from the group consisting of non-woven spunbonded olefins and cross-laminated polyolefins.

2. The airbag device of claim 1 wherein said high density polyolefin is selected from at least one of the group of non-woven spunbonded olefins consisting of ethylene and propylene, or, at least one of the group of cross-laminated polyolefins consisting of polyethylene, polypropylene, polymethylpentene, ethylene/propylene, ethylene, methylpentene, and propylene/methylpentene.

3. The airbag device of claim 1 wherein said polymeric material is a cross-laminated high density polyolefin.

4. The airbag device of claim 1 wherein said polymeric material exhibits porosity thereby venting gases upon airbag activation.

5. The airbag device of claim 5 wherein said porous polymeric material is at least partially covered by a non-porous material.

6. The airbag device of claim 1 wherein said polymeric material is non-porous.

7. The airbag device of claim 1 wherein said airbag is formed exclusively from cross-laminated high density polyethylene.

8. A vehicle occupant protection system containing the airbag device of claim 1 and an inflator for inflation of said airbag.

9. A method of manufacturing an airbag comprising the steps of:
providing at least one panel formed from nonwoven spunbonded olefin or from a cross-laminated plurality of layers of a polyolefin, wherein the panel defines a plurality of opposed edges;
mating or joining the opposed edges to form a desired shape; and
ironing or otherwise melting the opposed edges to form a pressurized airbag upon airbag activation.

10. The method of claim 9 wherein said panel is porous.

11. The method of claim 10 further comprising the step of at least partially covering the porous panel with a nonporous material.

12. The method of claim 9 wherein said panel is at least partially nonporous.

13. The method of claim 9 wherein said panel is formed exclusively from cross-laminated layers of high density polyethylene.

14. The method of claim 9 further comprising the steps of:
providing one or more panels formed from cross-laminated layers of polyolefin wherein the first panel defines a first plurality of opposed edges, and the second panel defines a second plurality of opposed edges corresponding to the first plurality of opposed edges;
overlaying the first panel over the second panel to join the first and second pluralities of opposed edges; and
ironing or melting the first and second pluralities of opposed edges together to form an airbag.

15. The method of claim 14 wherein each panel is formed exclusively from high density cross-laminated polyethylene.

16. The method of claim 9 further comprising the step of forming said airbag into a plurality of chambers by melt forming at least a portion of the perimeter of the chambers.

17. An airbag device formed from the method of claim 9.

18. A vehicle occupant protection device formed from the method of claim 9.

19. An airbag formed from the method of claim 9.
